(19) United States
(12) Patent Application Publication
(10) Pub. No.: US 2025/0293234 A1
(43) Pub. Date: Sep. 18, 2025

(54) ELECTRODE COMPOSITE MATERIAL AND SODIUM ION BATTERY

(71) Applicant: TOYOTA JIDOSHA KABUSHIKI KAISHA, Toyota-shi (JP)

(72) Inventor: Satoshi Mizutani, Okazaki-shi (JP)

(73) Assignee: TOYOTA JIDOSHA KABUSHIKI KAISHA, Toyota-shi (JP)

(21) Appl. No.: 18/963,929

(22) Filed: Nov. 29, 2024

(30) Foreign Application Priority Data
Mar. 14, 2024 (JP) 2024-040316

(51) Int. Cl. H01M 4/134; H01M 4/02; H01M 4/38; H01M 4/62; H01M 10/054

(52) U.S. Cl. CPC H01M 4/134; H01M 4/387; H01M 4/62; H01M 10/054; H01M 2004/021; H01M 2004/027

(57) ABSTRACT

An electrode composite material of the present disclosure contains an alloy of tin and cobalt, and a carbon material. In the electrode composite material of the present disclosure, the peak intensity of a CoSn₂ phase is larger than the peak intensity of a CoSn phase in an XRD spectrum, and the peak intensity of the CoSn₂ phase is larger than the peak intensity of a Sn phase in the XRD spectrum. A sodium ion battery of the present disclosure includes a negative electrode active material layer containing the electrode composite material of the present disclosure, an electrolyte layer containing a sodium ion, and a positive electrode active material layer.

### CROSS-REFERENCE TO RELATED APPLICATION

This application claims priority to Japanese Patent Application No. 2024-040316 filed on Mar. 14, 2024, incorporated herein by reference in its entirety.

### BACKGROUND

### 1. Technical Field

The present disclosure relates to an electrode composite material, and a sodium ion battery.

### 2. Description of Related Art

As disclosed in Japanese Unexamined Patent Application Publication No. 2015-022983, a battery using a tin-cobalt alloy as a negative electrode active material is known.

### SUMMARY

In a battery using a tin-cobalt alloy as a negative electrode active material, there is a room of improvement from the viewpoint of increase of the capacity.

An object of the present disclosure is to provide an electrode composite material capable of improving the capacity of a battery, and a sodium ion battery containing such an electrode composite material.

The present disclosers have found that the problem can be solved by the following means:

### Aspect 1

An electrode composite material containing an alloy of tin and cobalt, and a carbon material, wherein the peak intensity of a CoSn₂ phase is larger than the peak intensity of a CoSn phase in an XRD spectrum.

### Aspect 2

The electrode composite material according to aspect 1, wherein a ratio of the peak intensity of the CoSn₂ phase to the peak intensity of the CoSn phase in the XRD spectrum is 1.1 or more.

### Aspect 3

The electrode composite material according to aspect 1 or 2, wherein a ratio of the sum of the peak intensity of the CoSn₂ phase and the peak intensity of a Sn phase to the peak intensity of the CoSn phase in the XRD spectrum is 1.5 or more and 6.0 or less.

### Aspect 4

The electrode composite material according to any one of aspects 1 to 3, wherein a ratio of the mass of the tin to the total mass of the tin and the cobalt is 0.7 or more.

### Aspect 5

A sodium ion battery including a negative electrode active material layer containing the electrode composite material according to any one of aspects 1 to 4, an electrolyte layer containing a sodium ion, and a positive electrode active material layer.

According to the present disclosure, an electrode composite material capable of improving the capacity of a battery, and a sodium ion battery containing such an electrode composite material can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a sodium ion battery according to the present disclosure;

FIG. 2 illustrates XRD spectra of electrode composite materials of Production Example 1 and Comparative Production Example 1;

FIG. 3 is a graph illustrating the relationship between a ratio of the sum of the peak intensity of a CoSn₂ phase and the peak intensity of a Sn phase to the peak intensity of a CoSn phase ((CoSn₂ phase+Sn phase)/CoSn phase (peak intensity)), and a charge capacity of a sodium ion battery of each of Examples and Comparative Examples; and

FIG. 4 is a graph illustrating the relationship between a ratio of the mass of tin to the total mass of tin and cobalt (Sn/Sn+Co (mass)), and the charge capacity of the sodium ion battery of each of Examples and Comparative Examples.

### DETAILED DESCRIPTION OF EMBODIMENTS

Embodiments of the present disclosure will now be described in detail. It is noted that the present disclosure is not limited to the following embodiments, but can be practiced with various modifications made within the scope of the present disclosure.

### Electrode Composite Material

An electrode composite material of the present disclosure contains an alloy of tin and cobalt, and a carbon material. In the electrode composite material of the present disclosure, the peak intensity of a CoSn₂ phase is larger than the peak intensity of a CoSn phase in an XRD spectrum.

The present disclosers have unexpectedly achieved the present disclosure by paying attention to the presence of the CoSn₂ phase in a tin-cobalt (Sn—Co) alloy. Specifically, it has been found that the capacity of a battery can be improved by increasing the ratio of the CoSn₂ phase. The reason is, without intending to be bound to any theory, probably because a crystalline phase is appropriately controlled to cause tin to be easily involved in charge/discharge in the electrode composite material of the present disclosure. It is noted that a capacity herein means a charge capacity.

### Alloy of Tin and Cobalt

The electrode composite material of the present disclosure contains the alloy of tin and cobalt (Sn—Co alloy). Sn in the Sn—Co alloy has a function of absorbing and desorbing a diffuse ion such as a lithium ion, or a sodium ion, and accordingly is involved in charge/discharge of a battery. In other words, Sn functions as an electrode active material. Co in the Sn—Co alloy can contribute to improvement of cycle characteristics of the battery.

In the electrode composite material of the present disclosure, the peak intensity of the CoSn₂ phase is larger than the peak intensity of the CoSn phase in the XRD spectrum. In particular, in the XRD spectrum, a ratio of the peak intensity of the CoSn₂ phase to the peak intensity of the CoSn phase (CoSn₂ phase/CoSn phase (peak intensity)) may be 1.1 or more. This ratio may be 1.5 or more, 2.0 or more, or 2.5 or more, and may be 5.0 or less, 4.5 or less, or 4.0 or less. When this configuration is employed, the capacity of the battery can be improved.

A ratio of the peak intensity of the CoSn₂ phase to the peak intensity of a Sn phase (CoSn₂ phase/Sn phase (peak intensity)) may be 1.0 or more, 1.5 or more, 2.0 or more, 2.5 or more, or 3.0 or more, and may be 5.0 or less, 4.8 or less, or 4.5 or less. When this configuration is employed, the capacity of the battery can be improved without excessively impairing the cycle characteristics.

A ratio of the sum of the peak intensity of the CoSn₂ phase and the peak intensity of the Sn phase to the peak intensity of the CoSn phase ((CoSn₂ phase+Sn phase)/CoSn phase (peak intensity)) may be 1.5 or more and 6.0 or less. Particularly, this ratio may be 1.7 or more, 2.0 or more, 2.5 or more, or 3.0 or more, and may be 5.8 or less, 5.5 or less, or 5.0 or less. When this configuration is employed, the capacity of the battery can be improved without excessively impairing the cyclic characteristics.

A method for measuring each of the peak intensities by an X-ray diffraction method (XRD) is not especially limited. For example, each of the peak intensities can be obtained as follows with an average of peak intensities at 26 to 26.5° in the XRD spectrum used as a background value:
peak intensity of CoSn phase: a value obtained by subtracting the background value from the maximum value of the peak intensities at 33.8 to 34.2°
peak intensity of CoSn₂ phase: a value obtained by subtracting the background value from the maximum value of the peak intensities at 32.7 to 32.9°
peak intensity of Sn phase: a value obtained by subtracting the background value from the maximum value of the peak intensities at 30.3 to 30.9°

The XRD spectrum may be based on a diffraction peak obtained by X-ray diffraction performed using CuKα ray as characteristic X-ray at a sweep rate of 1°/min.

A ratio of the mass of the tin to the total mass of the tin and the cobalt (Sn/(Sn+Co) (mass)) may be 0.7 or more. Particularly, this ratio may be 0.75 or more, and may be less than 1.0, 0.9 or less, 0.85 or less, or 0.80 or less. When this configuration is employed, the capacity of the battery can be improved without excessively impairing the cycle characteristics.

The mass of the tin, and the mass of the cobalt can be quantitatively determined by energy dispersive X-ray fluorescence spectroscopy (EDX), and high-frequency inductively coupled plasma (ICP)-atomic emission spectroscopy.

### Carbon Material

The electrode composite material of the present disclosure contains a carbon material. The carbon material functions as a matrix of the Sn—Co alloy. The carbon material may be amorphous, and in this case, the carbon material may not be involved in the charge/discharge of the battery.

The content of the carbon material may be 10% by mass or more and 30% by mass or less. The content of the carbon material may be 11% by mass or more, 12% by mass or more, 13% by mass or more, 14% by mass or more, 15% by mass or more, or 16% by mass or more, and may be 28% by mass or less, 26% by mass or less, 24% by mass or less, 22% by mass or less, or 20% by mass or less.

The content of the carbon material can be quantitatively determined, for example, by a combustion method with a carbon-sulfur analyzer (CS analyzer).

### Method for Producing Electrode Composite Material

A method for producing an electrode composite material of the present disclosure is not especially limited, and an example includes a method in which a tin element, a cobalt element, and a carbon material are mixed by a mechanical alloying method. More specifically, for example, a method in which a tin element, a cobalt element, and a carbon material are mixed in an inert gas atmosphere with a ball mill at a prescribed rotation speed for a prescribed period of time can be employed.

In the method, a crystalline phase in a resultant Sn—Co alloy can be controlled, for example, by adjusting the amounts of the tin element and the cobalt element to be used.

### Sodium Ion Battery

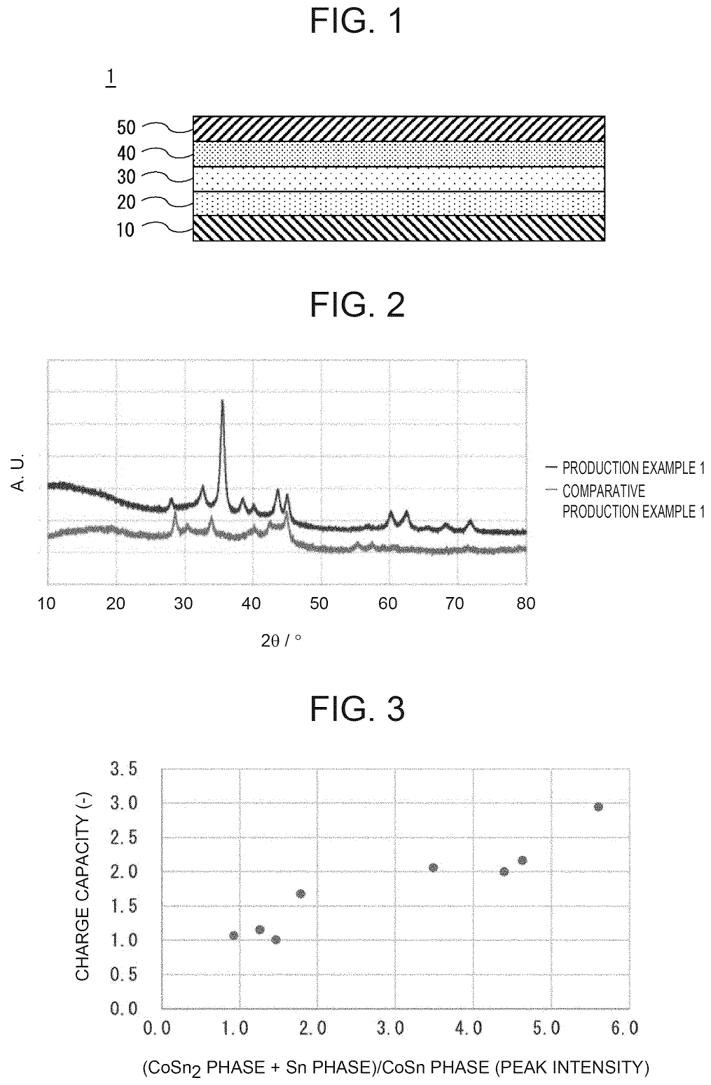

As exemplarily illustrated in FIG. 1, a sodium ion battery 1 of the present disclosure includes a negative electrode active material layer 20 containing an electrode composite material of the present disclosure, an electrolyte layer 30 containing a sodium ion, and a positive electrode active material layer 40. The sodium ion battery of the present disclosure may include a negative electrode current collector layer 10, the negative electrode active material layer 20 containing the electrode composite material of the present disclosure, the electrolyte layer 30, the positive electrode active material layer 40, and a positive electrode current collector layer 50.

The battery of the present disclosure may be a liquid battery, or a solid battery. In the present disclosure, the term “solid battery” means a battery using at least a solid electrolyte as the electrolyte, and accordingly, a solid battery may use, as the electrolyte, a combination of a solid electrolyte and a liquid electrolyte. Alternatively, the solid battery of the present disclosure may be an all-solid-state battery, namely, a battery using only a solid electrolyte as the electrolyte.

Examples of the shape of the sodium ion battery of the present disclosure include a coin shape, a laminate shape, a cylindrical shape, and a prismatic shape.

Now, the elements constituting the sodium ion battery of the present disclosure will be described.

### Negative Electrode Current Collector Layer

Examples of the material of the negative electrode current collector layer include SUS, aluminum, copper, nickel, and carbon.

The negative electrode current collector layer may be, for example, in a foil, mesh, or porous shape.

### Negative Electrode Active Material Layer

The negative electrode active material layer contains an electrode composite material of the present disclosure. The negative electrode active material layer of the present disclosure may optionally contain a conductive auxiliary agent and a binder. When the sodium ion battery of the present disclosure is a solid battery, the negative electrode active material layer may optionally contain a solid electrolyte.

### Electrode Composite Material

Regarding the electrode composite material, the description on the electrode composite material of the present disclosure given above can be referred to.

The content of the electrode composite material may be 50% by mass or more, 70% by mass or more, 80% by mass or more, 90% by mass or more, or 95% by mass or more, and may be less than 100% by mass, 99% by mass or less, 95% by mass or less, or 90% by mass or less.

### Conductive Auxiliary Agent

The conductive auxiliary agent may be, for example, a carbon material, a metal material, or the like. Specific examples of the carbon material include carbon black such as acetylene black, ketjen black, furnace black, or thermal black; carbon fiber such as VGCF; graphite; hard carbon; and coke. Examples of the metal material include Fe, Cu, Ni, and Al. One of these may be singly used, or a mixture of a plurality of these may be used. The content of the conductive auxiliary agent in the negative electrode active material layer is not especially limited, and may be appropriately determined in accordance with desired conductivity.

### Binder

As the binder, a chemically and electrically stable binder may be used. Specific examples of the binder include a fluorine-based binder such as a polyvinylidene fluoride (PVdF)-based biner, or a polytetrafluoroethylene (PTFE)-based binder; a rubber-based binder such as a styrene-butadiene rubber (SBR)-based binder; an olefin-based binder such as a polypropylene (PP)-based binder, or a polyethylene (PE)-based binder; a cellulose-based binder such as a carboxymethyl cellulose (CMC)-based binder; and a polyacrylic acid (PAA)-based binder. One of these may be singly used, or a mixture of a plurality of these may be used. The content of the binder in the negative electrode active material layer is not especially limited, and may be appropriately determined in accordance with a desired binding property.

### Solid Electrolyte

The solid electrolyte may be an inorganic solid electrolyte. Examples of the inorganic solid electrolyte include an oxide solid electrolyte, and a sulfide solid electrolyte. Examples of the oxide solid electrolyte include a NASION-based compound such as Na₃Zr₂Si₂PO₁₂, and β-alumina (Na₂O-11Al₂O₃). An example of the sulfide solid electrolyte includes Na₂S—P₂S₅. The shape of the solid electrolyte may be, for example, a particle shape.

The negative electrode active material layer may have a prescribed thickness. The thickness of the negative electrode active material layer is not especially limited, and may be, for example, 0.1 μm or more and 1 mm or less.

### Electrolyte Layer

When the battery of the present disclosure is a liquid battery, an electrolyte layer may be formed by impregnating a separator with an electrolytic solution.

### Separator

The material of the separator is not especially limited as long as it has a function of electrically separating a negative electrode active material layer and a positive electrode active material layer from each other, and examples include a porous sheet of a resin such as polyethylene (PE), polypropylene (PP), polyester, cellulose, or polyamide, a porous insulating material such as a nonwoven fabric, or a glass fiber nonwoven fabric, and a combination of these. The thickness of the separator is not especially limited, and may be, for example, 5 μm or more and 1 mm or less.

### Electrolytic Solution

The electrolytic solution may contain a sodium salt and a nonaqueous solvent. Examples of the sodium salt include inorganic sodium salts such as NaPF₆, NaBF₄, NaClO₄, and NaAsF₆; and organic sodium salts such as NaCF₃SO₃, NaN(CF₃SO₂)₂, NaN(C₂F₅SO₂)₂, NaN(FSO₂)₂, and NaC(CF₃SO₂)₃.

The nonaqueous solvent is not especially limited as long as it dissolves a sodium salt. Examples of the nonaqueous solvent include a high-dielectric constant solvent and a low-dielectric constant solvent. Examples of the high-dielectric constant solvent include cyclic esters (cyclic carbonates) such as ethylene carbonate (EC), propylene carbonate (PC), and butylene carbonate (BC), γ-butyrolactone, sulfolane, N-methyl-2-pyrrolidone (NMP), and 1,3-dimethyl-2-imidazolidinone (DMI). Examples of the low-dielectric constant solvent include chain esters (chain carbonates) such as dimethyl carbonate (DMC), diethyl carbonate (DEC), and ethyl methyl carbonate (EMC), acetates such as methyl acetate and ethyl acetate, and ethers such as 2-methyl tetrahydrofuran. A mixed solvent obtained by mixing a high-dielectric constant solvent and a low-dielectric constant solvent may be used.

When the battery of the present disclosure is a solid battery, the electrolyte layer contains a solid electrolyte, and may optionally contain a conductive auxiliary agent, a binder, and the like.

Regarding the solid electrolyte, the conductive auxiliary agent, and the binder, the description on the negative electrode active material layer of the present disclosure given above can be referred to.

### Positive Electrode Active Material Layer

The positive electrode active material layer contains a positive electrode active material, and may optionally contain a conductive auxiliary agent, a binder, and the like. When the battery of the present disclosure is a solid battery, the positive electrode active material layer may optionally contain a solid electrolyte.

As the positive electrode active material, a substance having a higher potential than the negative electrode active material may be used. Examples of such a positive electrode active material include a layered active material, a spinel active material, and a Na-containing oxide such as an olivine-type active material. Specific examples include NaFeO₂, NaNiO₂, NaCoO₂, NaMnO₂, NaVO₂, Na(NiₓMn₁₋ₓ)O₂ (wherein 0<X<1), Na(FeₓMn₁₋ₓ)O₂ (wherein 0<X<1), NaVPO₄F, Na₂FePO₄F, and Na₃V₂(PO₄)₃.

The content of the positive electrode active material may be 50% by mass or more, 70% by mass or more, 80% by mass or more, 90% by mass or more, or 95% by mass or more, and may be less than 100% by mass, 99% by mass or less, 95% by mass or less, or 90% by mass or less.

The shape of the positive electrode active material is not especially limited, and may be, for example, a particle shape. In this case, the average particle size may be, for example, 1 nm or more or 10 nm or more, and may be 100 μm or less or 30 μm or less.

Regarding the conductive auxiliary agent, the binder, and the solid electrolyte, the description on the negative electrode active material layer of the present disclosure given above can be referred to.

The positive electrode active material layer may have a prescribed thickness. The thickness of the positive electrode active material layer is not especially limited, and may be, for example, 0.1 μm or more and 1 mm or less.

### Positive Electrode Current Collector Layer

Examples of the material of the positive electrode current collector layer include SUS, aluminum, nickel, iron, titanium, and carbon.

The positive electrode current collector layer may be, for example, in a foil, mesh, or porous shape.

### Other Configurations

The sodium ion battery of the present disclosure may include a battery case for housing the respective layers of the battery, and a terminal connected to a current collector or the like. Besides, the battery of the present disclosure may include a restraining member for restraining the respective layers along the stacking direction for reducing contact resistance. As these components and members, those conventionally used may be used.

### Method for Producing Battery

A method for producing a sodium ion battery of the present disclosure may include forming a negative electrode active material layer containing an electrode composite material of the present disclosure.

A method for forming the negative electrode active material may be a wet method or a dry method.

A method for forming the negative electrode active material by a wet method may include providing a negative electrode mixture slurry containing a mixture material including the electrode composite material of the present disclosure, and a dispersion medium, applying the negative electrode mixture slurry to a substrate, and removing the dispersion medium by drying.

The dispersion medium is not especially limited, and examples include alcohol, glycol, cellosolve, amine, ketone, carboxylic acid amide, phosphoric acid amide, sulfoxide, carboxylic acid ester, phosphoric acid ester, ether, and nitrile. Specific examples include ethanol, 2-propanol, methyl ethyl ketone, and N-2-methyl pyrrolidone.

A drying temperature, a drying time, and the like may be appropriately designed in accordance with the boiling point, the usage and the like of the dispersion medium.

A method for forming the negative electrode active material layer by a dry method may include forming a green compact of a mixture material containing the electrode composite material on a substrate.

Regarding the electrode composite material used in the method for forming the negative electrode active material layer, the description on the electrode composite material of the present disclosure given above can be referred to.

The substrate is not especially limited, and may be, for example, a negative electrode current collector layer.

### Production Example 1

### Production of Electrode Composite Material

A raw material containing a tin element, a cobalt element, and a carbon material was weighed to a target composition ratio. The total mass of the raw material was 15 g. A 500 mL chromium steel container was charged with 400 g of SUS ball, and the weighed raw material. The container was purged with argon gas, and then sealed, and the raw material held therein was subjected to a treatment by a mechanical alloying method at a rotation speed of 250 rpm over 25 hours. After the treatment, the resultant material held in the container was collected, and classified with a mesh having an opening of 53 μm. In this manner, an electrode composite material of Production Example 1 was obtained.

### Quantitative Determination of Tin and Cobalt

The amounts of tin and cobalt in the resultant electrode composite material were quantitatively determined by energy dispersive X-ray fluorescence spectroscopy (EDX), and high-frequency inductively coupled plasma (ICP)-atomic emission spectroscopy.

### Measurement of Peak Intensity

The peak intensity of each crystalline phase of the tin-cobalt alloy was measured by an X-ray diffraction method (XRD). Specifically, the peak intensities were obtained as follows with an average of peak intensities at 26 to 26.5° in the XRD spectrum used as a background value:
peak intensity of CoSn phase: a value obtained by subtracting the background value from the maximum value of the peak intensities at 33.8 to 34.2°
peak intensity of CoSn₂ phase: a value obtained by subtracting the background value from the maximum value of the peak intensities at 32.7 to 32.9°
peak intensity of Sn phase: a value obtained by subtracting the background value from the maximum value of the peak intensities at 30.3 to 30.9°

The XRD spectrum was based on a diffraction peak obtained by X-ray diffraction performed using CuKα ray as characteristic X-ray at a sweep rate of 1°/min.

### Production Examples 2 to 5, and Comparative Production Examples 1 to 3

Electrode composite materials of Production Examples 2 to 5, and Comparative Production Examples 1 to 3 were obtained in the same manner as in Production Example 1 except that the peak intensities of the crystalline phases in the tin-cobalt alloy, and the ratio of the mass of tin to the total mass of tin and cobalt (Sn/(Sn+Co) (mass)) were changed as shown in Table 1.

### Examples 1 to 5 and Comparative Examples 1 to 3

### Production of Cell for Evaluation

The electrode composite material of each of Production Examples and Comparative Production Examples, acetylene black (AB), and polyvinylidene fluoride (PVdF) were weighed in a mass ratio of 85:10:5, and these were dispersed in N-methyl-2-pyrrolidone (NMP) to prepare a slurry. The thus obtained slurry was applied onto an aluminum foil used as a current collector foil, the resultant was pressed, and then dried in vacuum at 120° C. overnight to obtain a test electrode. A metallic sodium foil was used as a counter electrode. 1M NaPF₆ in PC was used as the electrolytic solution. Thus, electrochemical measurement coin cells (CR2032) of Examples 1 to 5 and Comparative Examples 1 to 3 were produced. It is noted that the numbers of Production Examples and Comparative Production Examples respectively accord with the numbers of Examples and Comparative Examples.

### Evaluation of Charge Capacity

The charge capacity of the cell for evaluation of each example was evaluated in a voltage range of 0.05 V to 1.5 V at 0.1 C rate. The evaluation was conducted within a constant temperature bath at 25° C. It is noted that a charge capacity means a capacity at the time of initial sodium doping reaction. Each evaluation result is indicated as a relative value obtained by assuming that the value of Comparative Example 1 is 1.00.

### Results

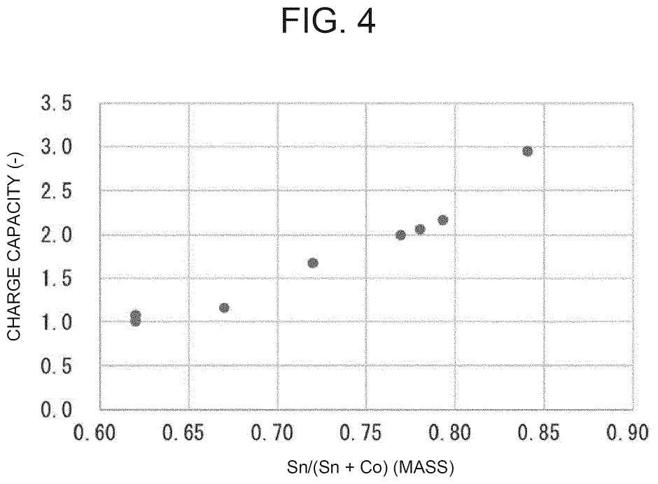

The XRD spectra of the electrode composite materials of Production Example 1 and Comparative Production Example 1 are illustrated in FIG. 2. The CoSn₂ phase/CoSn phase (peak intensity) and the CoSn₂ phase/Sn phase (peak intensity), the (CoSn₂ phase+Sn phase)/CoSn phase (peak intensity), and the relationship between the Sn/(Sn+Co) (mass) and the charge capacity of each example are shown in Table 1, and FIGS. 3 and 4.

TABLE 1

| | | | | (CoSn₂ phase + | | Charge |
|---|---|---|---|---|---|---|
| | Electrode | CoSn₂ phase/ | CoSn₂ phase/ | Sn phase)/ | | capacity |
| | composite | CoSn phase | Sn phase | CoSn phase | Sn/(Sn + Co) | (relative |
| | material | (peak intensity) | (peak intensity) | (peak intensity) | (mass) | value) |
| Com. | Com. | 0.64 | 0.77 | 1.47 | 0.6200 | 1.00 |
| Ex. 1 | Prod. Ex. 1 | | | | | |
| Com. | Com. | 0.29 | 0.46 | 0.93 | 0.6203 | 1.07 |
| Ex. 2 | Prod. Ex. 2 | | | | | |
| Com. | Com. | 0.64 | 1.01 | 1.27 | 0.6702 | 1.15 |
| Ex. 3 | Prod. Ex. 3 | | | | | |
| Ex. 1 | Prod. Ex. 1 | 1.18 | 1.91 | 1.79 | 0.7200 | 1.67 |
| Ex. 2 | Prod. Ex. 2 | 3.58 | 4.39 | 4.40 | 0.7697 | 1.99 |
| Ex. 3 | Prod. Ex. 3 | 2.71 | 3.44 | 3.50 | 0.7804 | 2.05 |
| Ex. 4 | Prod. Ex. 4 | 3.72 | 4.07 | 4.63 | 0.7932 | 2.15 |
| Ex. 5 | Prod. Ex. 5 | 2.01 | 0.56 | 5.61 | 0.8409 | 2.94 |

As illustrated in FIG. 2, in the electrode composite material of Production Example 1, the peak intensity of the CoSn₂ phase was larger than the peak intensity of the CoSn phase in the XRD spectrum. The same was found in the electrode composite materials of Production Examples 2 to 5. On the contrary, in the electrode composite material of Comparative Production Example 1, the peak intensity of the CoSn₂ phase was smaller than the peak intensity of the CoSn phase in the XRD spectrum. The same was found in the electrode composite materials of Comparative Production Examples 2 and 3.

As shown in Table 1, the batteries of Examples containing the electrode composite materials of Production Examples having the peak intensity of the CoSn₂ phase larger than the peak intensity of the CoSn phase had a larger charge capacity than the batteries of Comparative Examples containing the electrode composite materials of Comparative Production Examples having the peak intensity of the CoSn₂ phase smaller than the peak intensity of the CoSn phase.

What is claimed is:

1. An electrode composite material comprising an alloy of tin and cobalt, and a carbon material,
wherein a peak intensity of a CoSn₂ phase is larger than a peak intensity of a CoSn phase in an XRD spectrum.

2. The electrode composite material according to claim 1, wherein a ratio of the peak intensity of the CoSn₂ phase to the peak intensity of the CoSn phase in the XRD spectrum is 1.1 or more.

3. The electrode composite material according to claim 1, wherein a ratio of a sum of the peak intensity of the CoSn₂ phase and a peak intensity of a Sn phase to the peak intensity of the CoSn phase in the XRD spectrum is 1.5 or more and 6.0 or less.

4. The electrode composite material according to claim 1, wherein a ratio of a mass of the tin and a total mass of the tin and the cobalt is 0.7 or more.

5. A sodium ion battery comprising:
a negative electrode active material layer comprising the electrode composite material according to claim 1;
an electrolyte layer containing a sodium ion; and
a positive electrode active material layer.
